(19) United States
(12) Patent Application Publication
(10) Pub. No.: US 2025/0299166 A1
(43) Pub. Date: Sep. 25, 2025

(54) BLOCKCHAIN SYSTEM FOR DISTRIBUTING FUNDS FROM TOURISTS TO LOCAL RESIDENTS

(71) Applicant: Cameron Hepple, Montreal (CA)

(72) Inventor: Cameron Hepple, Montreal (CA)

(21) Appl. No.: 18/613,268

(22) Filed: Mar. 22, 2024

(51) Int. Cl. G06Q 20/06; G06Q 20/10

(52) U.S. Cl. CPC G06Q 20/065; G06Q 20/10; G06Q 2220/00

(57) ABSTRACT

The invention is a blockchain based digital currency for nations with a high rate of foreign tourism that allows for visitors to buy in to the local economy by directing the visitors to purchase the digital currency before they travel to the nation. The digital currency is divided up between the local population of the nation and a fund that is set up to directly offset the economic and environmental impacts of the tourists. The local residents have the ability to vote on how the funds are distributed to various local and national projects. This digital currency would enable visitors to feel positive about their visit, and allow locals to have a say in how the money is spent in their nation.

### BACKGROUND

Tourism is a boon to developing nations with pristine natural resources, allowing the taxes and money spent by tourists to help economic growth for the area and for the local residents, also the money goes to repair and maintain the region to make up for the added ecological wear caused by the tourists. But higher taxes on goods and services puts strains on the local businesses who must pass the higher costs onto customers. Another way to help out the local area and residents are for resorts to charge their guests fees to help sustain the area. Foreign investors can also step in, but their investment come with costs such as increased control on the locals. But again, higher prices, taxes, and fees are deterrents to tourists visiting an area. There has to be a way to help distribute tourist funds to local residents that everyone would find acceptable.

### SUMMARY OF THE INVENTION

The solution proposed is a digital currency that would allow for funds from tourists to be distributed to the local residents. The digital currency, Tourist Coin, would be used to stimulate community driven economic growth. This would be done by allowing the money from tourists to enable all citizens of the country or region to be paid a living income. Instead of endless fees and high taxes on goods and services, the tourists could feel good about their money going to help the local people directly. This could be used as a way of advertising the tourist destination to potential customers to lessen some of the guilt some feel when spending a lavish amount of money to go on vacation in a developing country or region.

The token or coin would be generated via a smart contract on the Hedera blockchain, but any other blockchain system could be used. The tokens would be funded by a landing tax for non-residents when they visit another country. The tokens would be automatically distributed to qualified citizens of a county or region. The qualified citizens could be based on age, legal status, how long the person has lived there, whether they have a national insurance number, or any other metric that could determine that a person is qualified to receive payments.

The tokens could also be purchased by the tourists or the residents for use themselves. This would allow for the tourists to barter with the residents or for the residents to barter with each other. This would allow for the residents to use the tokens for goods and services without having to pay a fee to turn the token into a fiat currency. The tourists could also use the tokens to purchase goods and services so that they would not have to convert their paper money into the local currency.

When converting the tokens into a fiat currency, there could be a fee involved, which could be a flat fee, or it could be a fee that is dynamic and fluctuates with certain factors such as the amount being converted or any other factor that could affect the conversion. Tokens could also be transferred between residents or tourists for any other reason, such as a loan or gift. If there are remaining tokens left after distributing them to the local residents, the tokens could be used to finance a local improvement project. The projects could be voted on by the local residents so that they have a feeling of self worth in their area.

The Tourist Coin would encourage tourists to visit by ensuring that their money is reach people that need it. The Tourist Coin would represent a bottom up economic policy by giving the money directly to the residents, who would use the tokens to goods and services in the area, increasing the tax revenue, which would allow the government to tackle issues that need addressing. The goal is to empower the people of a region to have pride in their community that encourages the local residents to live and enjoy life.

### BRIEF DESCRIPTIONS OF THE FIGURES

FIG. 1 shows the overview of the implantation of the system.

FIG. 2 shows a flowchart indicating the preferred embodiment of the invention.

### DETAILED DESCRIPTION

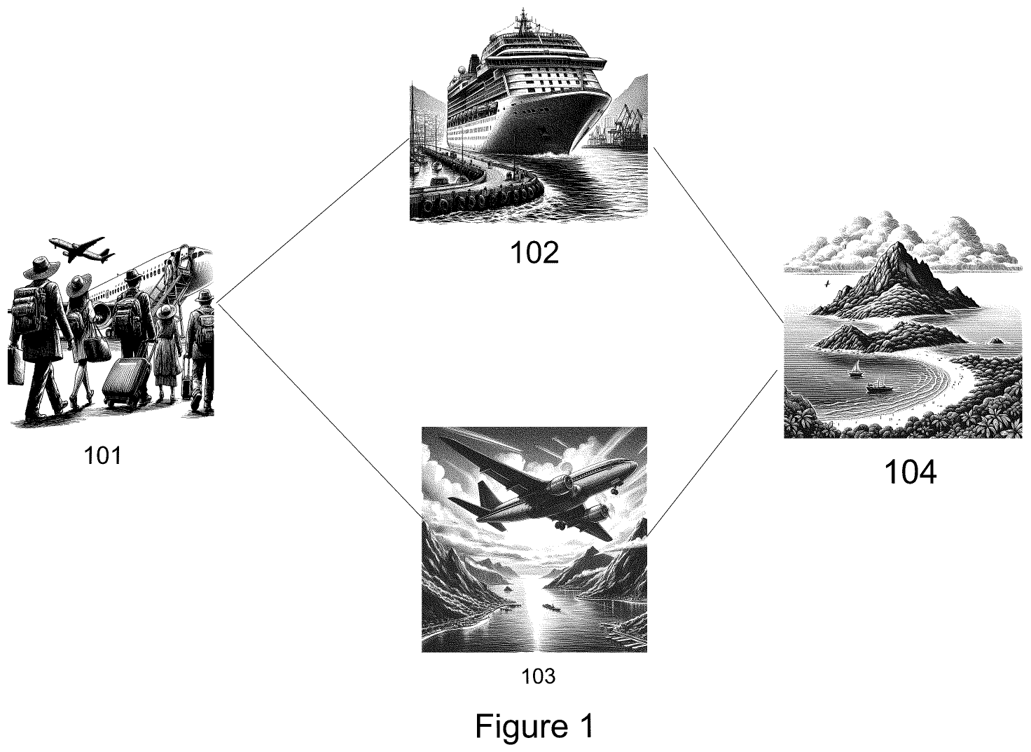

FIG. 1 shows a group of tourists 101 traveling to an island nation. While the application will refer to the nation or country as an island nation, the nation or country could be any place where people want to go to visit and support the local population. Tourism can be a boon to any country and many rely on the money earned from their tourist industries to support their local population. But with taxes and resort fees, the tourist can feel like they're being taken advantage of, while the local population may not reap the benefits from those tourists directly. The Tourist Coin is a cryptocurrency that allows for visitors to a country or region to purchase the currency with their native currency, which is then distributed to the local population and used to fund community projects. While the most common ways to reach tourist areas are usually by plane or ship, it is understood that visitors could use any legal way of egress to enter the country, such as car, helicopter, charter plane, or boat.

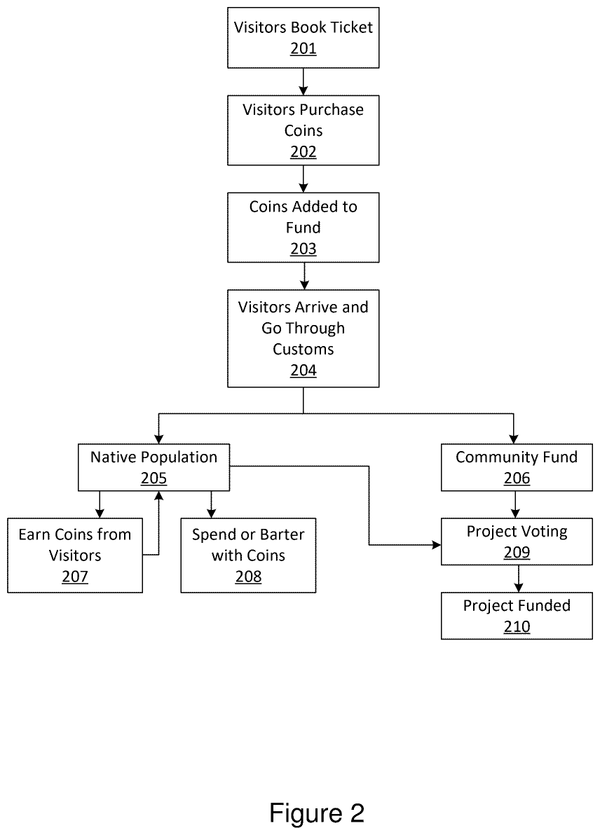

Shown in FIG. 2, when the visitors plan their trip and purchase their tickets for travel and their stay 201, then are required to purchase coins 202. The coins are immediately deposited into the fund that will be split in between the community fund and the native population 203. While the preferable embodiment of the invention would require visitors to purchase the coins before entering the country, there could be an option for the visitors to voluntarily purchase the coins, either at all or in addition to the coins required to enter the country. The visitors would be given access to their coins when they enter the country through customs 204. The value of the coins could be static, but preferably they'd fluctuate like any traditional currency. The

A portion of the funds would be distributed directly to the native/local population 205. The amount distributed to the population could be a fixed amount that each person receives, or it could be dynamic, changing as the population and their needs change. The distribution could be evenly split amongst all of the local people, or there could be a sliding scale based on, but not excluding, need, number of people, location of the people, or any other metric that could be used to fairly distribute funds amongst the local people. The local people, as well as the visitors to the country, would then use the coins to purchase goods and services in the country 207 and 208.

The remaining portion of the coin fund would be placed into a community fund for public use 206. The funds could be earmarked for local improvements to infrastructure such as roads, power lines, fresh water, farming, building schools or hospitals, funding local artists, or any other project that would help the local residents of the country. The decision to use the funds are preferably voted on by the local population so as to make sure that the funds are used in a way that is agreed upon by a majority 209. The voting could be in person, online, or any other manner to gauge how the population wants to use the funds. The result of the voting could be based on a simple majority, or voting from a list of options where the top three vote receivers would be funded, or any other method of determining the public wishes. Once the project(s) are voted on, the funds are used to start and complete the project 210. The local people hired to work on the projects would be paid in the coins from the funds, or they could be paid in the country's local currency.

The distribution of funds directly to the local population and to the public projects would create a sense of additional pride in their country and encourage the residents to make the country a place that tourists would want to continue to visit, which would then increase the amount of coins added to the fund. The public projects would preferably be easily visible projects that would be appreciated by the local population, as well as by the visitors, knowing that the money they spent on their vacation was going to help the local population.

The funds could also be distributed to the local population via a fee that is added to the purchase of the ticket. This fee could be a percentage of the price of the tickets or it could be a flat rate per ticket and/or passenger. The fee would be placed into an escrow account until the time of travel or when the passenger or parties are on the plane or boat. The fees would then be converted into the digital currency and distributed to the local population.

While any Blockchain technology could be used in create and operate the infrastructure to handle Tourist Coin distribution and transactions, the Hedera Block Chain system is preferred. Blockchain technology is widely regarded as a revolutionary, peer-to-peer, decentralized option for data organization. It allows for formation of decentralized monetary systems such as crypto-coins, smart contracts, and other resources that can be managed online, such as smart property. Blockchain can be used in distribute ledger systems and other financial transactions and allows different entities to exchange data and transactions quickly without intervention or verification by third parties. This can be accomplished through a shared data framework that utilizes computer algorithms to create real-time self-updates. Blockchain technology can also settle financial transactions without mediation from banks and other trusted institutions

A common framework for blockchain is a decentralized database in which transactions are recorded using a virtually unmodifiable cryptographic signature. Records can be added to the decentralized database to create blocks, that are protected against manipulation and alteration. Each block is connected to a previous block and has a timestamp. Different entities can create smart contracts based on a blockchain, without intervention from other entities. The data contained in such a smart contract is difficult to alter, as blocks cannot be changed after being formed. Thus, a smart contract on a blockchain can be a set of actions implemented on contributing nodes, creating mutual agreement in results of such transactions without need for third-party mediation of information and money.

In an example, parties negotiate and agree on conditions relating to a transaction. Once both parties' conditions for the exchange are fulfilled, a smart contract is created, coded, and archived in a blockchain structure. Data is recorded and managed (e.g., through use of Internet of Things (IoT) devices such as RFID, quick-response codes, and WSNs). Once the smart contract is created, goods and funds are transferred according to the terms of smart contract. No human mediation is required, and the transaction can proceed faster and at less cost as compared to non-blockchain transactions.

Electronic transactions can be digitally recorded via blockchains. A blockchain can be a decentralized list of electronic blocks, where each electronic block contains a timestamp of one or more transactions (e.g., the time at and/or about which such one or more transactions occurred), metadata characterizing the one or more transactions (e.g., amounts of cryptocurrencies involved in such one or more transactions, blockchain addresses from which and/or to which such amounts of cryptocurrencies were transferred during such one or more transactions), and/or a cryptographic hash of the previous electronic block. Because each electronic block can include a cryptographic hash of the previous electronic block, the blockchain can be resistant to retroactive tampering, which has led to a surge in the popularity of blockchain technology and a commensurate surge in the popularity of cryptocurrencies and increasing prevalence of electronic transactions involving smart contracts. However, as blockchain transactions and associated smart contracts become ubiquitous, the door is open to risk.

A recent advancement in blockchain technology relies on a hashgraph consensus algorithm developed by Hedera Hashgraph. The hashgraph consensus is a faster, more secure, and fair way of conducting transactions as opposed to traditional blockchain consensus such that the final consensus reached is abiding and documents are made available for public viewing on a public ledger. Hashgraph algorithms make it possible for transactions to be communicated via a more complex network as opposed to traditional blockchain, thereby providing an ideal interface for users to publish legally abiding contracts such as wills and liens, verify individuals' credentials for academic admissions, publish maintenance records for vehicles and track HW transportation such that they are perpetually available for public viewing in their most recent and accurate version.

In general, a smart contract can be computer code that automatically executes all or parts of an agreement and is stored on a blockchain-based platform. In an aspect, the smart contract (or code) can be the entirety of an agreement between parties. In another aspect, the smart contract can be code that implements certain provisions of a traditional written contract, e.g., moving funds between parties to the smart contract. The smart contract can be replicated across multiple nodes of a blockchain and, therefore, benefit from security, permanence and immutability associated with blockchain technology.

With Hedera Hashgraph, the underlying hashgraph consensus relies on algorithms that allow participating parties to maintain a distributed ledger on their devices (e.g., computers, other electronic device), wherein the devices are typically referred to as nodes. Nodes communicate amongst each other, and the common ledger which is present on each node is constantly updated as transactions are carried out. Each node has a copy of the exact order of transactions wherein the algorithm also records the date and time of transactions. This is achieved via a gossip-about-gossip protocol and virtual voting wherein a copy of the updated public ledger with information about every transaction can be present and perpetually updated on each participating individual's node (e.g., computer, other electronic device) such that every node can have details about the transaction, a time stamp, a digital signature and two cryptographic hashes—one corresponding to the last message that was sent and one corresponding to the last message that was received by a respective node. Thus, each node can have access to information about every transaction, including when the transaction was updated and communicated to other nodes. The hashgraph framework can also ensure that parties involved in or having access to transactions are not able to manipulate sensitive information. In this manner, Hedera Hashgraph provides a very transparent network which makes way for several potential uses.

One or more embodiments described herein can include systems, computer-implemented methods, apparatus, and/or computer program products that can facilitate publishing, tracking and asset transfer on blockchains or the Hedera network. In other words, various embodiments described herein can include a computerized tool (e.g., any suitable combination of computer-executable hardware and/or computer-executable software) that can electronically receive inputs.

The devices mentioned above could be implemented using any type of processor architecture able to execute software including, but not limited to, x86, ENIAC, RISC, Pentium™, and Apple Silicon™. The software could be any type of code that is used to instruct a processor to perform instructions including, but not limited to, Python™, Java™, C+™, FORTRAN, and Assembly. The software could be stored on any type of non-transitory medium including, but not limited to, RAM, ROM, Flash Memory, Punch Cards, Piano Player Reels, Hard Drives, and physical servers.

We claim:

1. A blockchain based digital currency for distributing funds from visitors to a local population comprising:
a blockchain system for prompting a visiting person to purchase a digital currency when they make travel to another region;
the digital currency being distributed to the local population of a region, wherein:
the digital currency is divided being a direct transfer to the local population and a public project fund, where
the public project fund is used to fund projects that are voted or approved by the local population;
the digital currency is used by the visitor and the local population to make transactions in the region to purchase goods and services.

2. A blockchain based digital currency as claimed in claim 1, further comprising:
wherein the person is prompted to purchase the digital currency when they purchase their tickets for travel.

3. A blockchain based digital currency as claimed in claim 1, further comprising:
wherein the person is prompted to purchase the digital currency when arriving at the region.

4. A blockchain based digital currency as claimed in claim 1, further comprising:
wherein the person is prompted to purchase the digital currency when the person reserves their lodging at the region.

5. A blockchain based digital currency as claimed in claim 1, further comprising:
wherein the digital currency is based on the Hedera blockchain.

6. A blockchain based digital currency as claimed in claim 1, further comprising:
wherein the amount of currency required for purchase is determined by the length of the visit.

7. A blockchain based digital currency as claimed in claim 1, further comprising:
wherein the amount of currency required for purchase is determined by the number of people visiting.

8. A blockchain based digital currency as claimed in claim 1, further comprising:
wherein the traveling is done by boat, car, or air travel.

9. A blockchain based digital currency as claimed in claim 1, further comprising:
wherein the public fund project focuses on the environment.

10. A blockchain based digital currency as claimed in claim 1, further comprising:
wherein the public fund project focuses on infrastructure.

11. A blockchain based digital currency as claimed in claim 1, further comprising:
wherein the voting is done online.

12. A blockchain based digital currency as claimed in claim 1, further comprising:
wherein the funds are distributed based upon the number of people living in a household.

13. The blockchain based digital currency as claimed in claim 1, further comprising:
wherein the digital currency can be transferred between other digital currency holders.

14. The blockchain based digital currency as claimed in claim 1, further comprising:
wherein the digital currency can exchanged for a fiat currency, which will incur a fee associated with the amount of currency being exchanged.
